(19) United States
(12) Patent Application Publication
(10) Pub. No.: US 2010/0122295 A1
(43) Pub. Date: May 13, 2010

(54) METHOD FOR DEFINING TELEVISION CONTENT LINEUP

(75) Inventors: Yolanda D. Thomas, Round Rock, TX (US); Jacqueline Anders, Round Rock, TX (US); Randal Anders, Austin, TX (US)

Correspondence Address: IBM CORPORATION US;c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/268,763

(22) Filed: Nov. 11, 2008

(51) Int. Cl. H04N 5/445

(52) U.S. Cl. 725/44; 725/58

(57) ABSTRACT

The present disclosure is directed to a method for defining a content lineup for a television. The method may comprise receiving a list of scheduled contents from at least one television channel; adding a plurality of user-selected contents to the content lineup having a start time and an end time, further comprising: receiving a selection for a first content from the list of scheduled contents for playing at the start time; determining a second start time based on the start time and a duration of the first content; receiving a selection for a second content from the list of scheduled contents for playing at the second start time; and playing the plurality of user-selected contents according to the content lineup during a period from the start time to the end time.

### TECHNICAL FIELD

The present disclosure generally relates to the field of electronics, and more particularly to a method for defining a content lineup for a television.

### BACKGROUND

Television shows/contents may comprise information such as suggested viewer age ranges, content ratings, and/or descriptions of the contents. Such information may be utilized by various channel selections or viewer programming methods to enhance television viewing experiences. For example, a method may provide parent abilities to pre-approve a show and/or a channel for kids to watch based on the age range and content rating of the show or the channel. In another example, a method may allow a viewer to define a list of favorite channels, hence, providing a way to scroll through only the favorite channels and skipping other channels in between. Moreover, viewers may record a selected list of shows/contents from various channels.

### SUMMARY

The present disclosure is directed to a method for defining a content lineup for a television. The method may comprise receiving a list of scheduled contents from at least one television channel; adding a plurality of user-selected contents to the content lineup having a start time and an end time, further comprising: receiving a selection for a first content from the list of scheduled contents for playing at the start time, wherein a broadcasting time of the first content is prior to or concurrent with the start time; recording at least partially the first content when the broadcasting time of the first content is prior to the start time; determining a second start time based on the start time and a duration of the first content; receiving a selection for a second content from the list of scheduled contents for playing at the second start time, wherein a broadcasting time of the second content is prior to or concurrent with the second start time; recording at least partially the second content when the broadcasting time of the second content is prior to the second start time; and playing the plurality of user-selected contents according to the content lineup during a period from the start time to the end time.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram illustrating a method for defining a content lineup for a television;

FIG. 2 is a diagram depicting an exemplary content lineup created based on scheduled television shows;

FIG. 3 is a diagram depicting another exemplary content lineup created based on scheduled television shows; and

FIG. 4 is a diagram depicting another exemplary content lineup created based on scheduled television shows.

### DETAILED DESCRIPTION

Reference will now be made in detail to the subject matter disclosed, which is illustrated in the accompanying drawings.

The present disclosure is directed to a method for defining a content lineup for a television. A television viewer may dynamically create a user-defined content/show lineup for viewing. The content lineup may comprise a start time, an end time, and a list of shows/programs selected from various channels to be played on the television during the period between the start time and the end time. While the actual broadcasting/airing times of the shows/programs selected for the lineup may overlap or vary, the selected shows in the content lineup may play automatically without any intervention (e.g., without having to manually change channels).

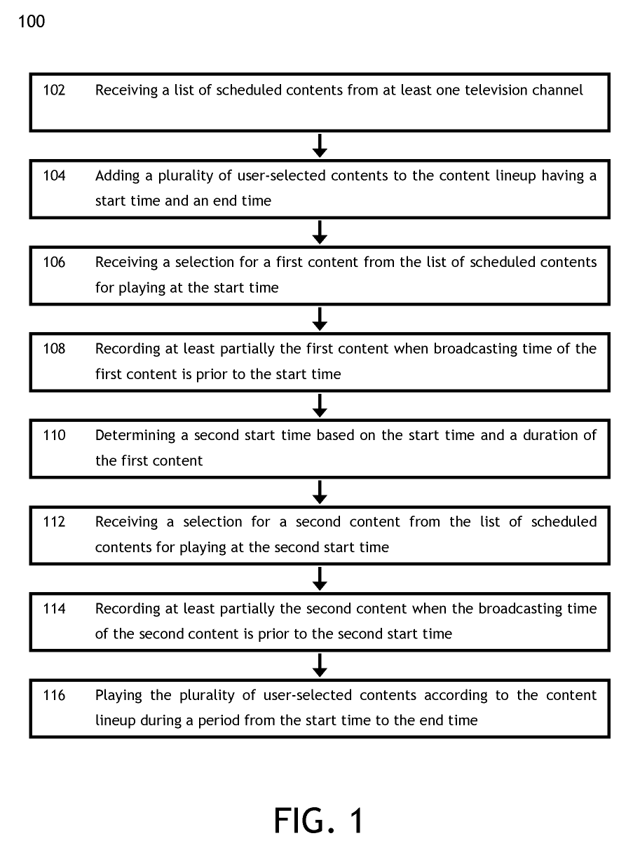

FIG. 1 shows a flow diagram illustrating steps performed by a method 100 in accordance with the present disclosure. Step 102 receives a list of scheduled contents from one or more television channels (e.g., channel guide information). The list of scheduled contents may be presented to the viewer through an interface (e.g., similar to a television guide or a digital video recorder (DVR) interface). Information presented on the interface may include, for example, channel listings with their airing times.

The viewer may then go through various channels/stations and define a desired content lineup. The content lineup may specify a start time and an end time, for example, from 7:00 PM to 9:00 PM. In one embodiment, the viewer may add a plurality of user-selected contents to the content lineup in step 104. This may be accomplished by selecting a first content/show from the list of scheduled contents for playing at the lineup start time (7:00 PM for example) in step 106. It is understood that the first show may be selected as long as the broadcasting time of the first show is prior to or concurrent with the start time of the lineup. For example, a show with broadcasting time at 8:00 PM may not be selected to start at 7:00 PM in the lineup. However, any show with broadcasting time prior to and/or at 7:00 PM may be selected. It is also understood that if the broadcasting time of the show selected is prior to the lineup start time, then at least a portion of the show may be recorded in step 108. For example, if the broadcasting time of the show is at 6:30 PM and the show is scheduled for 7:00 PM in the user-defined lineup, then the show may be recorded at 6:30 PM when broadcasting starts, and the recorded content may be presented to the viewer starting at 7:00 PM according to the lineup.

Once the first show is selected, step 110 determines a second start time of the lineup based on the lineup start time originally defined and duration of the first show. For example, if the original lineup start time is 7:00 PM, and the first show selected has duration of 60 minutes, then the second start time of the lineup is 8:00 PM. Once the second start time is determined, the viewer may select a second content/show from the list of scheduled contents for playing at the second start time in step 112. Similarly, the second show may be selected as long as the broadcasting time of the second show is prior to or concurrent with the second start time of the lineup. For example, a show with broadcasting time at 8:30 PM may not be selected to start at 8:00 PM in the lineup. However, any show with broadcasting time prior to and/or at 8:00 PM may be selected. Also similarly, if the broadcasting time of the second show selected is prior to the second lineup start time, then at least a portion of the second show may be recorded in step 114. For example, if the broadcasting time of the second show is at 4:00 PM and the show is scheduled for 8:00 PM in the user-defined lineup, then the show may be recorded at 4:00 PM when broadcasting starts, and the recorded content may be presented to the viewer starting at 8:00 PM according to the lineup.

Accordingly, the next lineup start time may be computed based on the second start time and duration of the second show. Subsequently, the viewer may continue to select the next show in the content lineup and so on. Once the content lineup is arranged, the user may save the arrangement and the user-selected contents/shows may be played according to the content lineup during the period between the start time and the end time in step 116. It is understood that the method in the present disclosure is applicable to all shows/contents available on all stations, and durations of the selected shows may vary (e.g., the first content may be a 60-minute show and the second content may be a 30-minute show). It is also understood that a viewer may define multiple content lineups, and each content lineup which may be modified, updated, or deleted by the viewer. For example, a viewer may modify a show scheduled at a particular time in one content lineup, and update the start and/or end time of another content lineup. A viewer may also control the duration to keep a content lineup before it is automatically deleted (e.g., automatically delete a content lineup after 2 weeks).

It is contemplated that the end time of the content lineup may be dynamically configured based on the selected contents. For example, if the content lineup start time is at 7:00 PM, and the content lineup contains one one-hour show and two half-hour shows, the end time of the lineup may be set at 9:00 PM if no further content is added to the lineup. It is also contemplated that, alternative to dynamically determining the next lineup start time based on start time and duration of the previously selected show (as illustrated in step 110), a predefined time frame (e.g., 30-minute or 60-minute) may be utilized. For example, a content lineup of two hours may be divided into four 30-minute time frames. A viewer may go through and select a television show to cover each time frame. Alternative implementations of the time frames may be employed without departing from the scope and spirit of the present disclosure.

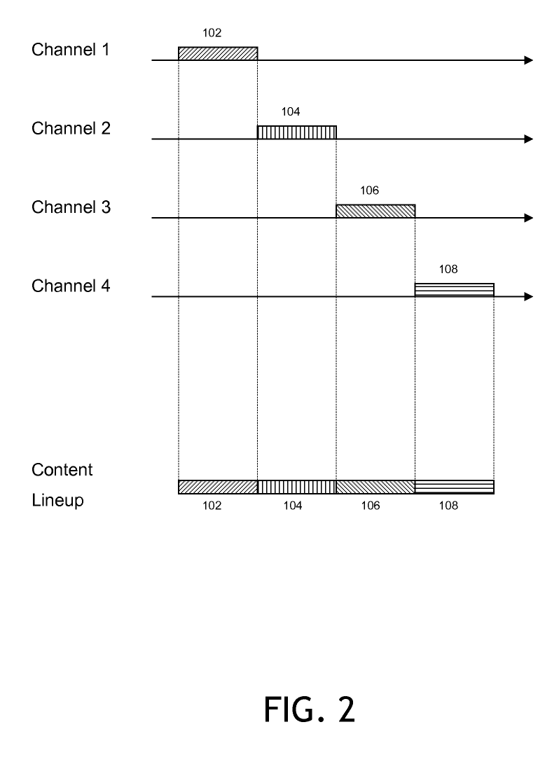

FIGS. 2 through 4 depict exemplary content lineups created based on scheduled television shows from channels 1 through 4. In FIG. 2, for example, a parent may define a set of television programs for a child to view for a span of time (e.g., from 6:00 PM to 8:00 PM). Based on the programs available on each television channel, the parent may select a first content 102 from channel 1, followed by a second content 104 from channel 2, followed by a third content 106 from channel 3, and followed by a fourth content 108 from channel 4. In this manner, minimal interaction or involvement may be required from the parent or caregiver. In addition, use of remote control to turn the channels between the shows may be reduced.

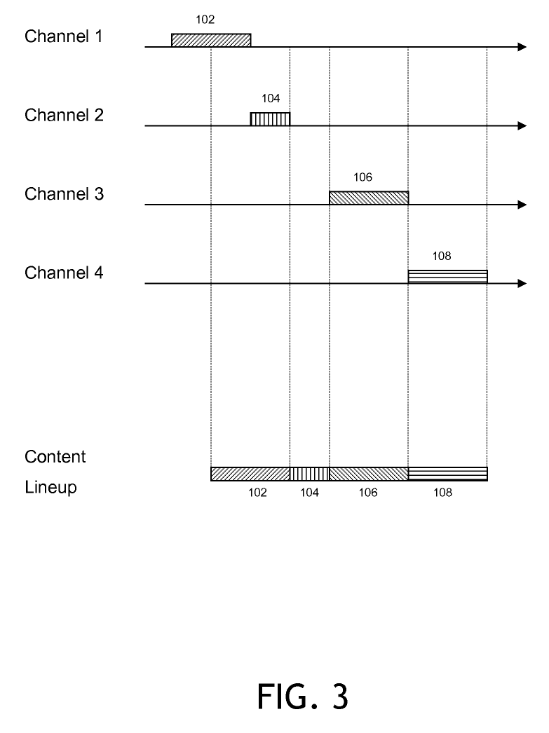

FIG. 3 depicts an example scenario where the broadcasting time of a show differs from the time the show is scheduled in the lineup. In this example, the first content 102 and the second content 104 have broadcasting times prior to their respective start times scheduled in the lineup. In one embodiment, the first content 102 and the second content 104 may be recorded when they are broadcasted, and may be presented to the viewer at their scheduled times according to the content lineup. The third content 106 and the fourth content 108 in this example may be presented to the viewer at their schedule times without recording, as their broadcasting time are concurrent with their scheduled times in the lineup.

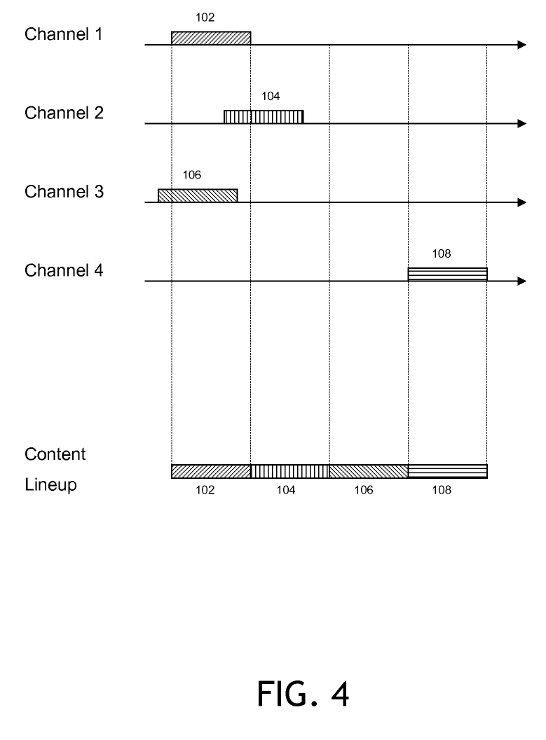

FIG. 4 depicts an example scenario where contents scheduled in the content lineup are in an order that is different from the order of which the contents are broadcasted. In this example, though content 106 is the first to broadcast, it may be scheduled as the third content in the lineup based on viewer preferences. It is noted that, though ordering in the content lineup may differ from the actual broadcasting orders, the content available for the lineup is still constrained by the broadcasting time of the content as previously described. For example, content 108 in this example may not be scheduled sooner (e.g., as the third content in the lineup) because it would not have been available (not yet broadcasted) at the time the third content starts. However, content 106 in this example may be scheduled sooner (e.g., as the first or second content in the lineup) because it is available (broadcast started) even prior to the start time of the lineup.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A method for defining a content lineup for a television, comprising:
receiving a list of scheduled contents from at least one television channel;
adding a plurality of user-selected contents to the content lineup having a start time and an end time, further comprising:
receiving a selection for a first content from the list of scheduled contents for playing at the start time, wherein a broadcasting time of the first content is prior to or concurrent with the start time;
recording at least partially the first content when the broadcasting time of the first content is prior to the start time;
determining a second start time based on the start time and a duration of the first content;
receiving a selection for a second content from the list of scheduled contents for playing at the second start time, wherein a broadcasting time of the second content is prior to or concurrent with the second start time;
recording at least partially the second content when the broadcasting time of the second content is prior to the second start time;
playing the plurality of user-selected contents according to the content lineup during a period from the start time to the end; and
receiving a time duration for keeping the content lineup; and
deleting the content lineup when the time duration expires.
